(19) United States
(12) Patent Application Publication
(10) Pub. No.: US 2023/0327201 A1
(43) Pub. Date: Oct. 12, 2023

(54) ELECTROLYTE FOR LITHIUM SECONDARY BATTERY AND LITHIUM SECONDARY BATTERY COMPRISING SAME

(71) Applicant: SAMSUNG SDI CO., LTD., Yongin-si, Gyeonggi-do (KR)

(72) Inventors: Hyunbong CHOI, Yongin-si (KR); Myunghoon KIM, Yongin-si (KR); Sanghoon KIM, Yongin-si (KR); Yunhee KIM, Yongin-si (KR); Injun PARK, Yongin-si (KR); Hongryeol PARK, Yongin-si (KR); Jeongmin SHIN, Yongin-si (KR); Seungryong OH, Yongin-si (KR); Myunghwan JEONG, Yongin-si (KR)

(21) Appl. No.: 18/005,336

(22) PCT Filed: Jun. 17, 2021
(86) PCT No.: PCT/KR2021/007587

§ 371 Date: Jan. 12, 2023

(30) Foreign Application Priority Data
Jul. 30, 2020 (KR) 10-2020-0095467

(51) Int. Cl. H01M 10/0567; H01M 10/052; H01M 4/525; H01M 4/131

(52) U.S. Cl. CPC H01M 10/0567; H01M 10/052; H01M 4/525; H01M 4/131

(57) ABSTRACT

Provided are an electrolyte for a lithium secondary battery, and a lithium secondary battery comprising same, the electrolyte including a nonaqueous organic solvent, a lithium salt, and an additive, wherein the additive is a composition including a first compound represented by Chemical Formula 1 and a second compound represented by Chemical Formula 2.

The details of Chemical Formulas 1 and 2 are the same as those described in the specification.

### TECHNICAL FIELD

This disclosure relates to an electrolyte for a lithium secondary battery and a lithium secondary battery including the same.

### BACKGROUND ART

A lithium secondary battery may be recharged and has three or more times as high energy density per unit weight as a conventional lead storage battery, nickel-cadmium battery, nickel hydrogen battery, nickel zinc battery and the like and may be also charged at a high rate and thus, is commercially manufactured for a laptop, a cell phone, an electric tool, an electric bike, and the like, and researches on improvement of additional energy density have been actively made.

Such a lithium secondary battery is manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions.

Particularly, an electrolyte includes an organic solvent in which a lithium salt is dissolved and critically determines stability and performance of a lithium secondary battery.

LiPF₆ that is most commonly used as a lithium salt of an electrolyte has a problem of reacting with an electrolytic solvent to promote depletion of a solvent and generate a large amount of gas. When LiPF₆ is decomposed, it generates LiF and PF₅, which leads to electrolyte depletion in the battery, resulting in degradation in high temperature performance and poor safety.

Accordingly, there is a demand for an electrolyte having improved safety without deterioration in performance even under high-temperature conditions.

### DISCLOSURE

### Technical Problem

An embodiment provides a lithium secondary battery with improved high-temperature cycle-life characteristics and storage characteristics by suppressing a decomposition of an electrolyte and side reactions with an electrode to suppress an increase in the internal resistance of the battery, thereby improving the battery stability, and at the same time reducing an amount of gas generated when left at high temperature.

### Technical Solution

An embodiment of the present invention provides an electrolyte for a lithium secondary battery including a nonaqueous organic solvent, a lithium salt, and an additive, wherein the additive is a composition including a first compound represented by Chemical Formula 1 and a second compound represented by Chemical Formula 2.

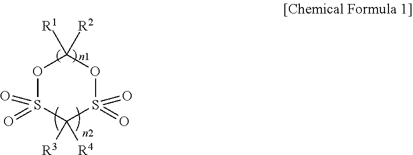

In Chemical Formula 1,
R¹ to R⁴ are each independently hydrogen, a halogen, a C1 to C10 alkyl group that is substituted or unsubstituted with a halogen, or a C2 to C10 alkenyl group, and
n1 and n2 are each independently one of integers of 1 to 3,

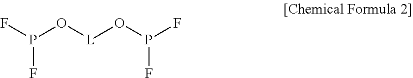

wherein, in Chemical Formula 2,
L is a substituted or unsubstituted C1 to C10 alkylene group, or a substituted or unsubstituted C2 to C10 ether group.

Each of n1 and n2 may each independently be an integer of 1 or 2.

Each of R¹ to R⁴ may be hydrogen.

The first compound may be methylenemethane disulfonate.

The second compound may be represented by Chemical Formula 2-1.

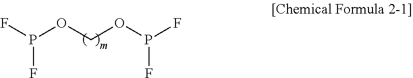

In Chemical Formula 2-1,
m is one of integers from 1 to 5.

The second compound may be represented by Chemical Formula 2-1a.

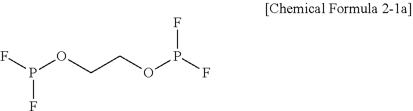

The first compound and the second compound may be included in a weight ratio of 1:1.5 to 1:4.

The first compound may be included in an amount of 0.2 wt % to 2 wt % based on the total weight of the electrolyte for a lithium secondary battery.

The second compound may be included in an amount of 0.5 wt % to 5 wt % based on the total weight of the electrolyte for a lithium secondary battery.

The first compound may be included in an amount of 0.2 wt % to 1 wt % based on the total weight of the electrolyte for a lithium secondary battery and the second compound may be included in an amount of 0.5 wt % to 2 wt % based on the total weight of the electrolyte for a lithium secondary battery.

The composition may be included in an amount of 0.7 wt % to 3 wt % based on the total weight of the electrolyte for a lithium secondary battery.

Another embodiment of the present invention provides a lithium secondary battery including a positive electrode including a positive electrode active material, a negative electrode including a negative electrode active material, and the aforementioned electrolyte for a lithium secondary battery.

The positive electrode active material may be at least one type of lithium composite oxide represented by Chemical Formula 3.

LiₐM¹_{1-y1-z1}M²_{y1}M³_{z1}O₂ [Chemical Formula 3]

In Chemical Formula 3,

0.9≤a≤1.8, 0≤y1<1, 0≤z1<1, 0≤y1+z1<1, and M¹, M², and M³ are each independently one selected from a metal such as Ni, Co, Mn, Al, Sr, Mg, or La, and a combination thereof.

The positive electrode active material may be a lithium composite oxide represented by Chemical Formula 3-1.

Liₓ₂Ni_{y2}CO_{z2}Al_{1-y2-z2}O₂ [Chemical Formula 3-1]

In Chemical Formula 3-1,

1≤x2≤1.2, 0.5≤y2≤1, and 0≤z2≤0.5.

The negative electrode active material may include a Si—C composite including a Si-based active material and a carbon-based active material.

### Advantageous Effects

It is possible to implement a lithium secondary battery with improved initial resistance and high temperature characteristics by suppressing an increase in the internal resistance of the battery and reducing an amount of gas generated when left at a high temperature.

### DESCRIPTION OF THE DRAWINGS

FIG. 1 is a schematic view illustrating a lithium secondary battery according to an embodiment of the present invention.

### DESCRIPTION OF SYMBOLS

100: lithium secondary battery
112: negative electrode
113: separator
114: positive electrode
120: battery case
140: sealing member

### MODE FOR INVENTION

Hereinafter, a lithium secondary battery according to an embodiment of the present disclosure will be described in detail with reference to the accompanying drawings. However, these embodiments are exemplary, the present invention is not limited thereto and the present invention is defined by the scope of claims.

A lithium secondary battery may be classified into a lithium ion battery, a lithium ion polymer battery, and a lithium polymer battery depending on kinds of a separator and an electrolyte. It also may be classified to be cylindrical, prismatic, coin-type, pouch-type, and the like depending on shape. In addition, it may be bulk type and thin film type depending on sizes. Structures and manufacturing methods for lithium ion batteries pertaining to this disclosure are well known in the art.

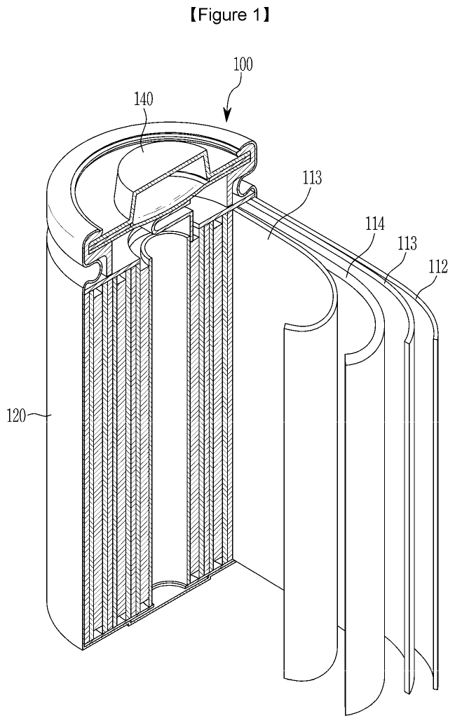

Herein, a cylindrical lithium secondary battery will be exemplarily described as an example of the lithium secondary battery. FIG. 1 schematically shows the structure of a lithium secondary battery according to an embodiment. Referring to FIG. 1, a lithium secondary battery 100 according to an embodiment includes a battery cell including a positive electrode 114, a negative electrode 112 facing the positive electrode 114, a separator 113 between the positive electrode 114 and the negative electrode 112, and an electrolyte (not shown) impregnating the positive electrode 114, the negative electrode 112, and the separator 113, a battery case 120 housing the battery cell, and a sealing member 140 sealing the battery case 120.

Hereinafter, a more detailed configuration of the lithium secondary battery 100 according to an embodiment of the present invention will be described.

A lithium secondary battery according to an embodiment of the present invention includes an electrolyte, a positive electrode, and a negative electrode.

The electrolyte includes a non-aqueous organic solvent, a lithium salt and an additive, wherein the additive is a composition including a first compound represented by Chemical Formula 1 and a second compound represented by Chemical Formula 2.

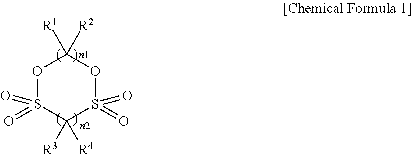

In Chemical Formula 1,
R¹ to R⁴ are each independently hydrogen, a halogen, a C1 to C10 alkyl group that is substituted or unsubstituted with a halogen, or a C2 to C10 alkenyl group, and
n1 and n2 are each independently one of integers of 1 to 3,

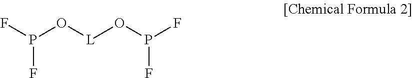

wherein, in Chemical Formula 2,
L is a substituted or unsubstituted C1 to C10 alkylene group, or a substituted or unsubstituted C2 to C10 ether group.

A cyclic sulfonate-based compound such as the first compound is reduced and decomposed before the carbonate-based solvent included in the non-aqueous organic solvent and thus may form an SEI (Solid Electrolyte Interface) film on the negative electrode to prevent decomposition of the electrolyte and decomposition of the electrode due to the electrolyte decomposition and thus to suppress an increase in internal resistance due to gas generation.

In addition, the first compound forms a film even on the surface of the positive electrode to prevent decomposition of the positive electrode surface and oxidation of the electrolyte and thus contribute to improving high temperature cycle-life characteristics.

In other words, the composition includes the first compound represented by Chemical Formula 1 and thus may improve cycle-life characteristics and safety of a battery.

In addition, the first compound is included with a phosphite-based compound such as the second compound and thus may suppress the high temperature decomposition of the electrolyte through stabilization of a lithium salt in the electrolyte and further improve suppression of the gas generation inside a battery at a high temperature.

When the first compound and the second compound are used as a combination, compared with when each compound is used alone, a much more film is formed on the negative electrode surface, much improving high temperature cycle-life characteristics.

For example, n1 and n2 in Chemical Formula 1 may each independently be an integer of 1 or 2.

For example, R¹ to R⁴ in Chemical Formula 1 may each be hydrogen.

For example, the first compound may be methylenemethane disulfonate.

For example, the second compound may be represented by Chemical Formula 2-1.

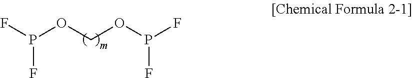

In Chemical Formula 2-1,
m is one of integers from 1 to 5,

As a specific example, the second compound may be represented by Chemical Formula 2-1a.

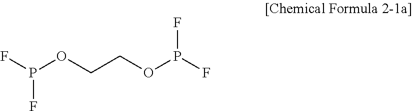

According to the most specific embodiment, the additive included in the electrolyte for a lithium secondary battery according to the present invention is a composition including methylenemethane disulfonate as the first compound and the compound represented by Chemical Formula 2-1a as the second compound.

In an embodiment, the first compound and the second compound may be included in a weight ratio of 1:1.5 to 1:4.

In a specific embodiment, the first compound and the second compound may be included in a weight ratio of greater than 1:greater than 1.5 and less than or equal 1:3.

Meanwhile, the first compound may be included in an amount of about 0.2 wt % to about 2 wt % based on the total weight of the electrolyte for a lithium secondary battery.

For example, it may be included in an amount of about 0.2 wt % to about 1.5 wt %, for example about 0.2 wt % to about 1 wt %.

In addition, the second compound may be included in an amount of about 0.5 wt % to about 5 wt % based on the total weight of the electrolyte for a lithium secondary battery.

For example, it may be included in an amount of about 0.5 wt % to about 4 wt %, about 0.5 wt % to about 3 wt %, or about 0.5 wt % to about 2 wt %, for example about 0.5 wt % to 1.5 wt %.

For example, the first compound may be included in an amount of about 0.2 wt % to about 1 wt % based on the total weight of the electrolyte for a lithium secondary battery and the second compound may be included in an amount of about 0.5 wt % to about 2 wt % based on the total weight of the electrolyte for a lithium secondary battery.

Specifically, the first compound may be included in an amount of about 0.2 wt % to about 1 wt % based on the total weight of the electrolyte for a lithium secondary battery, and the second compound may be included in an amount of 0.5 wt % to 1.5 wt % based on the total weight of the electrolyte for a lithium secondary battery.

The composition including the first compound and the second compound may be included in an amount of about 0.7 wt % to about 3 wt % based on the total weight of the electrolyte for a lithium secondary battery.

For example, the composition including the first compound and the second compound may be included in an amount of 1 wt % to 3 wt % based on the total weight of the electrolyte for a lithium secondary battery.

When the content of the composition, and the content of each component, that is, the first compound and the second compound in the composition, are within the above ranges, an increase in internal resistance of the battery may be effectively suppressed, and gas generation inside the battery may be suppressed, so that the It is possible to implement a lithium secondary battery with improved battery characteristics.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. The ester-based solvent may include methyl acetate, ethyl acetate, n-propyl acetate, t-butyl acetate, methylpropionate, ethylpropionate, propylpropionate, decanolide, mevalonolactone, caprolactone, and the like.

The ether-based solvent may include dibutyl ether, tetraglyme, diglyme, dimethoxyethane, 2-methyltetrahydrofuran, tetrahydrofuran, and the like. In addition, the ketone-based solvent may be cyclohexanone and the like. The alcohol-based solvent may include ethanol, isopropyl alcohol, and the like and the aprotic solvent may include nitriles such as R¹⁷—CN (wherein R¹⁷ is a hydrocarbon group having a C2 to C20 linear, branched, or cyclic structure and may include a double bond, an aromatic ring, or an ether bond), and the like, dioxolanes such as 1,3-dioxolane, and the like, sulfolanes, and the like.

The non-aqueous organic solvent may be used alone or in a mixture of one or more, and when one or more are mixed and used, the mixing ratio may be appropriately adjusted according to the desired battery performance, which is widely understood by those in the art.

In addition, in the case of the carbonate-based solvent, it is desirable to use a mixture of a cyclic carbonate and a chain carbonate. In this case, when the cyclic carbonate and the chain carbonate are mixed in a volume ratio of 5:5 to 1:9, the electrolyte may exhibit excellent performance.

In particular, in an embodiment of the present invention, the non-aqueous organic solvent may include the cyclic carbonate and the chain carbonate in a volume ratio of 5:5 to 2:8, and as a specific example, the cyclic carbonate and the chain carbonate may be included in a volume ratio of 4:6 to 2:8.

As a more specific example, the cyclic carbonate and the chain carbonate may be included in a volume ratio of 3:7 to 2:8.

The non-aqueous organic solvent may further include an aromatic hydrocarbon-based organic solvent in addition to the carbonate-based solvent. In this case, the carbonate-based solvent and the aromatic hydrocarbon-based solvent may be mixed in a volume ratio of 1:1 to 30:1.

The aromatic hydrocarbon-based solvent may be an aromatic hydrocarbon-based compound represented by Chemical Formula 4.

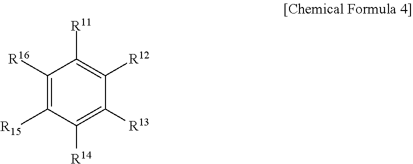

In Chemical Formula 4, R¹¹ to R¹⁶ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The lithium salt dissolved in the non-organic solvent supplies lithium ions in a battery, enables a basic operation of a lithium secondary battery, and improves transportation of the lithium ions between positive and negative electrodes. Examples of the lithium salt may include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiN(CₓF₂ₓ₊₁SO₂)(C_{y}F_{2y+1}SO₂), wherein x and y are natural numbers, for example, an integer ranging from 1 to 20, LiCl, LiI, and LiB(C₂O₄)₂ (lithium bis(oxalato) borate: LiBOB). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

The positive electrode includes a positive electrode current collector and a positive electrode active material layer on the positive electrode current collector and the positive electrode active material layer includes a positive electrode active material.

The positive electrode active material may include lithiated intercalation compounds that reversibly intercalate and deintercalate lithium ions.

Specifically, one or more composite oxides of a metal selected from cobalt, manganese, nickel, and a combination thereof, and lithium may be used.

Of course, one having a coating layer on the surface of the composite oxide may be used, or a mixture of the composite oxide and the composite oxide having a coating layer may be used. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound. For example, the method may include any coating method (e.g., spray coating, dipping, etc.), but is not illustrated in more detail since it is well-known to those skilled in the related field.

The positive electrode active material may be, for example, at least one of lithium composite oxides represented by Chemical Formula 3.

LiₐM¹_{1-y1-z1}M²_{y1}M³_{z1}O₂ [Chemical Formula 3]

In Chemical Formula 3,

0.9≤a≤1.8, 0≤y1 <1, 0≤z1<1, 0≤y1+z1<1, and M¹, M², and M³ are each independently one selected from a metal such as Ni, Co, Mn, Al, Sr, Mg, or La, and a combination thereof.

In an embodiment, M¹ may be Ni and M² and M³ may each independently be a metal of Co, Mn, Al, Sr, Mg, or La.

In a specific embodiment, M¹ may be Ni, M² may be Co, and M³ may be Mn or Al, but they are not limited thereto.

In a more specific embodiment, the positive electrode active material may be a lithium composite oxide represented by Chemical Formula 3-1.

Liₓ₂Ni_{y2}CO_{z2}Al_{1-y2-z2}O₂ [Chemical Formula 3-1]

In Chemical Formula 6-1, 1≤x2≤1.2, 0.5≤y2<1, and 0≤z2≤0.5.

A content of the positive electrode active material may be 90 wt % to 98 wt % based on the total weight of the positive electrode active material layer.

In an embodiment of the present invention, the positive electrode active material layer may optionally include a conductive material and a binder. In this case, a content of the binder may be 1 wt % to 5 wt % based on the total weight of the positive electrode active material layer.

A content of the conductive material may be 1 wt % to 5 wt %, respectively, based on the total weight of the positive electrode active material layer.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The binder improves binding properties of positive electrode active material particles with one another and with a current collector and examples thereof may bepolyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The positive electrode current collector may include Al, but is not limited thereto.

The negative electrode includes a negative electrode current collector and a negative electrode active material layer including a negative electrode active material formed on the negative electrode current collector.

The negative electrode active material may include a material that reversibly intercalates/deintercalates lithium ions, lithium metal, lithium metal alloy, material being capable of doping/dedoping lithium, or a transition metal oxide.

The material that reversibly intercalates/deintercalates lithium ions may include a carbon material and the carbon material may be any generally-used carbon-based negative electrode active material in a lithium secondary battery.

Examples thereof may be crystalline carbon, amorphous carbon, or a mixture thereof. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, Si—C composite, SiOx (0<x<2), a Si-Q alloy wherein Q is an element selected from an alkali metal, an alkaline-earth metal, a Group 13 element, a Group 14 element, a Group 15 element, a Group 16 element, a transition metal, a rare earth element, and a combination thereof, and not Si), Sn, SnO₂, Sn—R (wherein R is an element selected from an alkali metal, an alkaline-earth metal, a Group 13 element, a Group 14 element, a Group 15 element, a Group 16 element, a transition metal, a rare earth element, and a combination thereof, and not Sn), and the like and at least one of these materials may be mixed with SiO2.

The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be vanadium oxide, lithium vanadium oxide, or lithium titanium oxide.

In a specific embodiment, the negative electrode active material may be a Si—C composite including a Si-based active material and a carbon-based active material.

In the Si—C composite, an average particle diameter of the Si-based active material may be 50 nm to 200 nm.

When the average particle diameter of the Si-based active material is within the above range, volume expansion occurring during charging and discharging may be suppressed, and a break in a conductive path due to particle crushing during charging and discharging may be prevented.

The Si-based active material may be included in an amount of 1 wt % to 60 wt %, for example, 3 wt % to 60 wt % based on the total weight of the Si—C composite.

In another specific embodiment, the negative electrode active material may further include crystalline carbon together with the aforementioned Si—C composite.

When the negative electrode active material includes a Si—C composite and crystalline carbon together, the Si—C composite and crystalline carbon may be included in the form of a mixture, and in this case, the Si—C composite and crystalline carbon may be included in a weight ratio of 1:99 to 50:50. More specifically, the Si—C composite and crystalline carbon may be included in a weight ratio of 5:95 to 20:80.

The crystalline carbon may include, for example, graphite, and more specifically, natural graphite, artificial graphite, or a mixture thereof.

The average particle diameter of the crystalline carbon may be 5 μm to 30 μm.

In the present specification, the average particle diameter may be a particle size (D50) at 50% by volume in a cumulative size-distribution curve.

The Si—C composite may further include a shell surrounding the surface of the Si—C composite, and the shell may include amorphous carbon.

The amorphous carbon may include soft carbon, hard carbon, a mesophase pitch carbonized product, calcined coke, or a mixture thereof.

The amorphous carbon may be included in an amount of 1 to 50 parts by weight, for example 5 to 50 parts by weight, or 10 to 50 parts by weight based on 100 parts by weight of the carbon-based active material.

In the negative electrode active material layer, the negative electrode active material may be included in an amount of 95 wt % to 99 wt % based on the total weight of the negative electrode active material layer.

In an embodiment of the present disclosure, the negative electrode active material layer includes a binder, and optionally a conductive material. In the negative electrode active material layer, a content of the binder may be 1 wt % to 5 wt % based on the total weight of the negative electrode active material layer. When the negative electrode active material layer includes a conductive material, the negative electrode active material layer includes 90 wt % to 98 wt % of the negative electrode active material, 1 wt % to 5 wt % of the binder, and 1 wt % to 5 wt % of the conductive material.

The binder improves binding properties of negative electrode active material particles with one another and with a current collector. The binder includes a non-water-soluble binder, a water-soluble binder, or a combination thereof.

The non-water-soluble binder may be selected from polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylenecopolymer, polyethyleneoxide, polyvinylpyrrolidone, polyepichlorohydrine, polyphosphazene, polyacrylonitrile, polystyrene, an ethylenepropylenediene copolymer, polyvinylpyridine, chlorosulfonated polyethylene, latex, a polyester resin, an acrylic resin, a phenolic resin, an epoxy resin, polyvinyl alcohol, and a combination thereof.

When the water-soluble binder is used as a negative electrode binder, a cellulose-based compound may be further used to provide viscosity. The cellulose-based compound includes one or more of carboxymethyl cellulose, hydroxypropylmethyl cellulose, methyl cellulose, or alkali metal salts thereof. The alkali metals may be Na, K, or Li. Such a thickener may be included in an amount of 0.1 to 3 parts by weight based on 100 parts by weight of the negative electrode active material.

The conductive material is included to provide electrode conductivity and any electrically conductive material may be used as a conductive material unless it causes a chemical change and examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum silver, and the like; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

A separator may exist between the positive electrode and the negative electrode depending on the type of the lithium secondary battery. Such a separator may for example include polyethylene, polypropylene, polyvinylidene fluoride or and multi-layers thereof such as a polyethylene/polypropylene double-layered separator, a polyethylene/polypropylene/polyethylene triple-layered separator, a polypropylene/polyethylene/polypropylene triple-layered separator, and the like.

### DETAILED DESCRIPTION OF THE EMBODIMENTS

Hereinafter, examples of the present invention and comparative examples are described. These examples, however, are not in any sense to be interpreted as limiting the scope of the invention.

### Manufacture of Lithium Secondary Battery Cell

### Example 1

Positive electrode active material slurry was prepared by using LiNi_{0.91}Co_{0.07}Al_{0.02}O₂ as a positive electrode active material, polyvinylidene fluoride as a binder, and ketjen black as a conductive material in a weight ratio of 97:2:1 and dispersing the mixture in N-methyl pyrrolidone.

The positive electrode active material slurry was coated on a 14 μm-thick Al foil, dried at 110° C., and pressed to manufacture a positive electrode.

A negative electrode active material was prepared by mixing graphite and an Si—C composite in a weight ratio of 93:7, and then the negative electrode active material, a styrene-butadiene rubber binder, and carboxylmethyl cellulose were mixed in a weight ratio of 97:1:2 and then, dispersed in distilled water to prepare negative electrode active material slurry.

The Si—C composite had a core including artificial graphite and silicon particles and coated with coal pitch on the surface, wherein a content of the silicon was about 3 wt % based on the total weight of the Si—C composite.

The negative electrode active material slurry was coated on a 10 μm-thick Cu foil, dried at 100° C., and pressed to manufacture a negative electrode.

An electrode assembly was manufactured by assembling the manufactured positive and negative electrodes, and a separator made of polyethylene having a thickness of 25 μm, and an electrolyte was injected to prepare a lithium secondary battery cell.

The electrolyte has a following composition.

(Composition of Electrolyte)

Salt: LiPF₆ 1.5 M

Solvent: ethylene carbonate: ethylmethyl carbonate:dimethyl carbonate (EC:EMC:DMC=a volume ratio of 20:10:70)

Additive: a composition including 0.5 wt % of methylenemethane disulfonate represented Chemical Formula 1a, and 1 wt % of a compound represented by Chemical Formula 2-1a

(Herein, in the electrolyte composition, “wt %” is based on the total amount of an electrolyte (a lithium salt+a non-aqueous organic solvent+an additive))

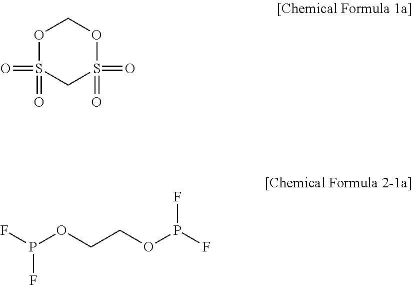 [SMILES: O=S1(=O)CS(=O)(=O)OCO1 ; FP(F)OCCOP(F)F]

### Example 2

A lithium secondary battery cell was manufactured in the same manner as in Example 1 except that the electrolyte was prepared by using an additive composition including 0.25 wt % of methylenemethane disulfonate represented by Chemical Formula 1a and 1 wt % of a compound represented by Chemical Formula 2-1a.

### Example 3

A lithium secondary battery cell was manufactured in the same manner as in Example 1 except that the electrolyte was prepared by using an additive composition including 0.5 wt % of methylenemethane disulfonate represented by Chemical Formula 1a and 0.75 wt % of a compound represented by Chemical Formula 2-1a.

### Comparative Example 1

A lithium secondary battery cell was manufactured in the same manner as in Example 1 except that the electrolyte was prepared by including no additives.

### Comparative Example 2

A lithium secondary battery cell was manufactured in the same manner as in Example 1 except that the electrolyte was prepared by using an additive composition including no compound represented by Chemical Formula 2-1a.

### Comparative Example 3

A lithium secondary battery cell was manufactured in the same manner as in Example 1 except that the electrolyte was prepared by using an additive composition including no compound represented by Chemical Formula 1a.

### Comparative Example 4

A lithium secondary battery cell was manufactured in the same manner as in Example 1 except that the electrolyte was prepared by using an additive composition including a compound represented by Chemical Formula b (1,3-propane sultone) instead of the compound represented by Chemical Formula 1a.

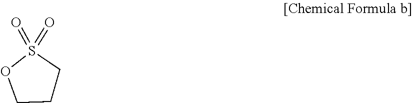

### Comparative Example 5

A lithium secondary battery cell was manufactured in the same manner as in Example 1 except that the electrolyte was prepared by using an additive composition including a compound represented by Chemical Formula c instead of the compound represented by Chemical Formula 2-1a.

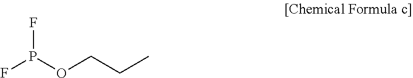

### Comparative Example 6

A lithium secondary battery cell was manufactured in the same manner as in Example 1 except that the electrolyte was prepared by using an additive composition including 0.75 wt % of methylenemethane disulfonate represented by Chemical Formula 1a and 1 wt % of the compound represented by Chemical Formula 2-1a.

### Comparative Example 7

A lithium secondary battery cell was manufactured in the same manner as in Example 1 except that the electrolyte was prepared by using an additive composition including 0.5 wt % of methylenemethane disulfonate represented by Chemical Formula 1a and 0.25 wt % of the compound represented by Chemical Formula 2-1a.

Each additive composition of the lithium secondary battery cells according to Examples 1 to 3 and Comparative Examples 1 to 7 is shown in Table 1.

TABLE 1

| | Additive composition | |
|---|---|---|
| | First compound (wt %) | Second compound (wt %) |
| Example 1 | Chemical Formula 1a | Chemical Formula 2-1a |
| | (0.5) | (1) |
| Example 2 | Chemical Formula 1a | Chemical Formula 2-1a |
| | (0.25) | (1) |
| Example 3 | Chemical Formula 1a | Chemical Formula 2-1a |
| | (0.5) | (0.75) |
| Comparative | — | — |
| Example 1 | | |
| Comparative | Chemical Formula 1a | — |
| Example 2 | (0.5) | |
| Comparative | — | Chemical Formula 2-1a |
| Example 3 | | (1.0) |
| Comparative | Chemical Formula b | Chemical Formula 2-1a |
| Example 4 | (0.5) | (1.0) |
| Comparative | Chemical Formula 1a | Chemical Formula c |
| Example 5 | (0.5) | (1.0) |
| Comparative | Chemical Formula 1a | Chemical Formula 2-1a |
| Example 6 | (0.75) | (1) |
| Comparative | Chemical Formula 1a | Chemical Formula 2-1a |
| Example 7 | (0.5) | (0.25) |

### Evaluation 1: Evaluation of Internal Resistance Characteristics When Left at High Temperature

The lithium secondary battery cells according to Examples 1 to 3 and Comparative Examples 1 to 7 were left at 60° C. for 30 days in a state of charge (=100%, SOC) to evaluate an internal resistance increase rate, when stored at a high temperature of 60° C., and the results are shown in Table 2.

DC-IR was measured in the following method.

The cells according to Examples 1 to 3 and Comparative Examples 1 to 7 were charged at 4 A and 4.2 V and cut off at 100 mA at room temperature of 25° C. and then, paused for 30 minutes. Subsequently, the cells were respectively discharged at 10 A for 10 seconds, at 1 A for 10 seconds, and at 10 A for 4 seconds and then, measured with respect to a current and a voltage at 18 seconds and 23 seconds to calculate initial resistance (a difference between resistance at the 18 seconds and resistance at the 23 seconds) according to an equation of ΔR=ΔV/ΔI.

The cells were charged under a condition of 0.2 C and 4.2 V and left at 60° C. for 30 days to measure DC-IR, resistance increase rates before and after being left were calculated according to Equation 1, and the results are shown in Table 2.

Resistance increase rate (%)=[DC-IR after being left for 30 days/DC-IR before being left]×100 <Equation 1>

TABLE 2

| | Initial | DC-IR | |
|---|---|---|---|
| | DC-IR | (mOhm) | Δ DC-IR |
| | (mOhm) | 60° C. @30 days | (%) |
| Example 1 | 41.43 | 48.12 | 116.1 |
| Example 2 | 41.45 | 49.13 | 118.5 |
| Example 3 | 41.45 | 49.12 | 118.5 |
| Comparative Example 1 | 42.29 | 51.33 | 121.4 |
| Comparative Example 2 | 42.35 | 51.12 | 120.7 |
| Comparative Example 3 | 42.34 | 50.89 | 120.2 |
| Comparative Example 4 | 42.45 | 52.13 | 122.8 |
| Comparative Example 5 | 42.12 | 51.39 | 122.0 |
| Comparative Example 6 | 42.56 | 50.56 | 118.8 |
| Comparative Example 7 | 41.56 | 49.86 | 120.0 |

Referring to Table 2, the secondary battery cells according to Examples 1 to 3 exhibited that the resistance increase rates were reduced before and after allowed to stand at a high temperature, compared with the cells according to Comparative Examples 1 to 7. Accordingly, the secondary battery cells according to Examples 1 to 3 exhibited improved high temperature stability, compared with the cells according to Comparative Examples 1 to 7.

Evaluation 3: Measurement of Amount of Gas Generated after High-Temperature Storage

For the lithium secondary battery cells according to Example 1 and Comparative Examples 1 to 5, amounts (ml) of gas generated when stored at 60° C. for 7 days, were measured using a refinery gas analyzer (RGA) and the results are shown in Table 3.

TABLE 3

| | Amount of gas generated after |
|---|---|
| | high-temperature storage for 7 days (mL) |
| Example 1 | 0.038 |
| Comparative Example 1 | 0.066 |
| Comparative Example 2 | 0.055 |
| Comparative Example 3 | 0.056 |
| Comparative Example 4 | 0.058 |
| Comparative Example 5 | 0.078 |

Referring to Table 3, the lithium secondary battery cell according to Example 1 exhibited a significantly reduced amount of generated gas after the high-temperature storage, compared with the cell including no additive according to Comparative Example 1, the cell including a sulfonate-based additive alone according to Comparative Example 2, the cell including a phosphite-based additive alone according to Comparative Example 3, the cell including a sulfone-based additive instead of the sulfonate-based additive according to Comparative Example 4, and the cell including a mono-fluoro phosphite-based additive instead of the difluoro phosphite-based additive according to Comparative Example 5. Accordingly, when an electrolyte according to an example embodiment of the present invention was applied, swelling characteristics of the lithium secondary battery cells were improved.

### Evaluation 4: Evaluation of Room Temperature Cycle-Life Characteristics

The lithium secondary battery cells according to Example 1 and Comparative Examples 1 to 5 were charged under charge conditions of constant current-constant voltage of 1.0 C and 4.2 V and cut-off at 0.33 C and discharged under discharge conditions of charge and constant current of 1.0 C and 3.0 V at room temperature of 25° C. for 200 cycles and then, measured with respect to discharge capacity to calculate a ratio of discharge capacity at the 200^{th} cycles to discharge capacity at the 1^{st} cycle (capacity retention), and the results are shown in Table 4.

TABLE 4

| | Recovery capacity @200 cycles (%) |
|---|---|
| Example 1 | 93.3 |
| Comparative Example 1 | 91.6 |
| Comparative Example 2 | 91.8 |
| Comparative Example 3 | 91.7 |
| Comparative Example 4 | 89.7 |
| Comparative Example 5 | 90.6 |

Referring to Table 4, the lithium secondary battery cell of Example 1 exhibited improved recovery capacity, compared with the cell including no additive according to Comparative Example 1, the cell including a sulfonate-based additive alone according to Comparative Example 2, the cell including a phosphite-based additive alone according to Comparative Example 3, the cell including a sulfone-based additive instead of the sulfonate-based additive according to Comparative Example 4, and the cell including a mono-fluoro phosphite-based additive instead of difluoro phosphite-based additive according to Comparative Example 5.

In other words, Example 1 according to the present invention exhibited excellent charge and discharge cycle characteristics, compared with Comparative Examples 1 to 5, achieving excellent cycle-life characteristics by including an additive composition according to the present invention.

Accordingly, lithium secondary battery cells using a composition of a specific combination according to the present example significantly improved storage characteristics at a high temperature and cycle-life characteristics.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. An electrolyte for a lithium secondary battery, comprising
a non-aqueous organic solvent,
a lithium salt, and
an additive,
wherein the additive is a composition including a first compound represented by Chemical Formula 1 and a second compound represented by Chemical Formula 2: 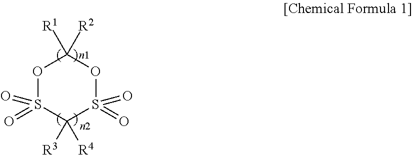
wherein, in Chemical Formula 1,
R¹ to R⁴ are each independently hydrogen, a halogen, a C1 to C10 alkyl group that is substituted or unsubstituted with a halogen, or a C2 to C10 alkenyl group, and
n1 and n2 are each independently one of integers of 1 to 3; 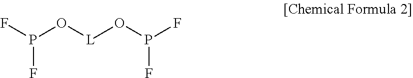
wherein, in Chemical Formula 2,
L is a substituted or unsubstituted C1 to C10 alkylene group, or a substituted or unsubstituted C2 to C10 ether group.

2. The electrolyte for a lithium secondary battery of claim 1, wherein
the n1 and n2 are each independently an integer of 1 or 2.

3. The electrolyte for a lithium secondary battery of claim 1, wherein
R¹ to R⁴ are each hydrogen.

4. The electrolyte for a lithium secondary battery of claim 1, wherein
the first compound is methylenemethane disulfonate.

5. The electrolyte for a lithium secondary battery of claim 1, wherein
the second compound is represented by Chemical Formula 2-1: 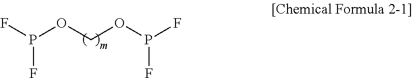
wherein, in Chemical Formula 2-1,
m is one of integers from 1 to 5.

6. The electrolyte for a lithium secondary battery of claim 5, wherein
the second compound is represented by Chemical Formula 2-1a:

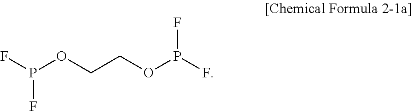

7. The electrolyte for a lithium secondary battery of claim 1, wherein the first compound and the second compound are included in a weight ratio of 1:1.5 to 1:4.

8. The electrolyte for a lithium secondary battery of claim 1, wherein the first compound is included in an amount of 0.2 wt % to 2 wt % based on the total weight of the electrolyte for a lithium secondary battery.

9. The electrolyte for a lithium secondary battery of claim 1, wherein
the second compound is included in an amount of 0.5 wt % to 5 wt % based on the total weight of the electrolyte for a lithium secondary battery.

10. The electrolyte for a lithium secondary battery of claim 1, wherein
the first compound is included in an amount of 0.2 wt % to 1 wt % based on the total weight of the electrolyte for a lithium secondary battery, and
the second compound is included in an amount of 0.5 wt % to 2 wt % based on the total weight of the electrolyte for a lithium secondary battery.

11. The electrolyte for a lithium secondary battery of claim 1, wherein
the composition is included in an amount of 0.7 wt % to 3 wt % based on the total weight of the electrolyte for a lithium secondary battery.

12. A lithium secondary battery, comprising
a positive electrode including a positive electrode active material,
a negative electrode including a negative electrode active material; and
the electrolyte for a lithium secondary battery of claim 1.

13. The lithium secondary battery of claim 12, wherein
the positive electrode active material is at least one type of lithium composite oxide represented by Chemical Formula 3:
LiₐM¹_{1-y1-z1}M²_{y1}M³_{z1}O₂ [Chemical Formula 3]
wherein, in Chemical Formula 3,
0.9≤a≤1.8, 0≤y1 <1, 0≤z1<1, 0≤y1+z1<1, and M¹, M², and M³ are each independently one selected from a metal of Ni, Co, Mn, Al, Sr, Mg, or La, and a combination thereof.

14. The lithium secondary battery of claim 12, wherein
the positive electrode active material is a lithium composite oxide represented by Chemical Formula 3-1:
Liₓ₂Ni_{y2}CO_{z2}Al_{1-y2-z2}O₂ [Chemical Formula 3-1]
wherein, in Chemical Formula 3-1,
1≤x2≤1.2, 0.5≤y2<1, and 0≤z2≤0.5.

15. The lithium secondary battery of claim 1, wherein
the negative electrode active material includes a Si—C composite including a Si-based active material and a carbon-based active material.
